(19) United States
(12) Patent Application Publication
(10) Pub. No.: US 2006/0175161 A1
(43) Pub. Date: Aug. 10, 2006

(54) Disc brake assembly with components to improve responsiveness

(75) Inventors: Joakim Gripemark, Helsingborg (SE); Patrik Kall, Helsingborg (SE); Goran Stensson, Brosarp (SE)

Correspondence Address: ST. ONGE STEWARD JOHNSTON & REENS, LLC, 986 BEDFORD STREET, STAMFORD, CT, 06905-5619, US

(73) Assignee: Haldex Brake Products AB

(21) Appl. No.: 11/363,737

(22) Filed: Feb. 28, 2006

Related U.S. Application Data
(63) Continuation of application No. PCT/SE04/01230, filed on Aug. 25, 2004.

(30) Foreign Application Priority Data
Aug. 29, 2003 (SE) 0302327-2

(51) Int. Cl. F16D 65/12

(52) U.S. Cl. 188/218 XL

(57) ABSTRACT

A disc brake comprising one or more brake discs received sliding or not sliding on a sleeve or the like connected to a wheel mount. The brake further comprises a caliper or the like and one or more brake pads received on back plates. The back plate is normally received sliding in the caliper or the like. The caliper and/or each back plate are elastically flexible in the direction of pad movement during brake application.

### CROSS-REFERENCE TO RELATED APPLICATIONS

This application is a continuation of International Patent Application No. PCT/SE2004/001230 filed on Aug. 25, 2004, which designates the United States and claims priority of Swedish Patent Application No. 0302327-2 filed on Aug. 29, 2003.

### FIELD OF THE INVENTION

The present invention concerns a disc brake, and more specifically the cooperation between back plates or the like and a caliper or other support means.

The brake is developed for heavy-duty vehicles, but a person skilled in the art realizes that the brake could be used for any type of vehicle, and that the brake could be any type of disc brake.

### BACKGROUND OF THE INVENTION

Disc brakes have normally either a fixed, a sliding or a swinging caliper. The present invention is intended for brakes having a fixed, a sliding or a swinging caliper.

Disc brakes are furnished with one or more brake discs cooperating with one or more brake pads to accomplish braking of the vehicle. The brake discs may be sliding or fixed on a central part such as a hub, sleeve or the like received on the hub and rotating when the wheel rotates. It is also known to use discs that are fixed, but that are rather elastic in the actuation direction. The brake pads are normally arranged on back plates. One back plate for each brake pad. The back plates are received sliding or fixed in a caliper or other support means. It is also relatively common to use other pad receiving means besides back plates. Furthermore, the back plates may have many alternative designs. It is e.g. relatively common to use a loose back plate, i.e. a back plate to which the brake pads are not directly fixed or otherwise integrated with. The caliper or other support means is mounted to a non-rotating part of the wheel receiving arrangement or other stationary part of the vehicle. At braking a thrust plate or the like of the brake mechanism presses on one back plate holding a brake pad and brings it in contact with a brake disc, which in turn may make contact with a further brake pad and so on in case of several discs. Thus, all of the brake pads and brake discs are moved into contact, in a manner well known to a person skilled in the art.

To simplify the description the term “caliper” is normally used in a broad sense here and it should be construed to include any support means for the back plates or the like carrying the brake pads. Furthermore, the expression “sleeve” is often used in a broad sense to cover any central part connected to a hub or the like and receiving the brake disc(s). In some embodiments the “sleeve” could be said to be formed of the hub, which hub receives the brake discs. Furthermore, “wheel receiving means” is used as a general expression for all different ways a wheel may be mounted to a vehicle. Depending on the position of the wheel, if it is driven or non-driven, the type of vehicle etc. the wheel may be mounted in many different ways, with or without the use of a proper wheel axle.

To accomplish braking a brake mechanism acts to bring the brake pads into contact with the brake disc or discs. When a brake pad comes into contact with a rotating brake disc the brake pad, and, thus, the pad receiving means will be urged against the caliper by the rotation of the brake disc. A friction force in the direction of pad movement will be generated between, caliper and pad receiving means due to the actuation movement and the force created in the contact with the rotating disc. By the expression “the direction of pad movement” as used in this description is meant the direction of the rotational axis of the brake disc(s). This could also be expressed as the direction of pad movement urged by the brake mechanism. The magnitude of actuation movement is also depending on the elasticity of the discs and brake pads, and their support. The pad movement urged by the brake mechanism during application of the brake is mainly a translation against the disc, but it may also include minor tilting of the pad. The direction of the friction force will be reversed when the brake alters from an actuation phase to a release phase. Hereby a hysteresis is created in the relationship between actuation force' and brake torque. This hysteresis is often quite extensive.

### SUMMARY OF THE INVENTION

The disc brake of the present invention has one or more brake discs sliding or not sliding on a sleeve or the like connected to a wheel receiving means. The caliper, or other support means, is mounted on vehicle axles or similar non-rotating part of the vehicle structure. Brake pads are received sliding in the caliper during brake actuation.

The pad receiving means, such as back plates or similar parts, transmitting the braking force from the pads to the caliper, and/or the caliper are elastically flexible in the direction of the pad movement during the application of the brake. The friction forces between the pad receiving means and the caliper in the direction of pad movement during actuation are large enough to produce elastic deflection of the pad receiving means and/or the caliper of the same magnitude as the compressions of pad and disc material. In other words, the deflection is of the same magnitude as the sliding during actuation force build-up would have been if the pad receiving means and/or the caliper were stiff instead of flexible. Thus, when designing the brake the elastic flexibility of the brake pads and/or the caliper is set depending on the expected actuation movements in the brake.

Elastic deflection instead of sliding means that the force in the direction of pad movement is not changing to its opposite direction when the brake alters from an actuation phase to a release phase. That will reduce the hysteresis in the relationship between actuation force and braking torque compared to a case with normal sliding friction forces. Expressed differently the present invention reduces the lag time from when the brake pedal or the like is pressed until the braking force is applied to the wheels of the vehicle. Also the lag time in “reversed” action is reduced, i.e. from when the brake pedal or the like is released until the braking force to the wheels is removed. In other words, reducing hysteresis improves responsiveness of the braking system to user input. Low hysteresis and good responsiveness are particularly beneficial for ABS brakes (Anti-lock Brake System).

One object of the present invention is that the hysteresis in the relationship between actuation force and brake torque should be reduced, compared to brakes functioning in a conventional way with a larger amount of sliding in the contact between pad and caliper.

The above object is met with a disc brake having one or more brake discs received sliding or not sliding on a sleeve or the like connected to a wheel receiving means. The brake further comprises a caliper or the like and one or more brake pads received on pad receiving means. The pad receiving means is normally received sliding in the caliper or the like. The caliper and/or each pad receiving means are elastically flexible in the direction of pad movement during brake application.

The type and magnitude of the elasticity utilized to improve responsiveness depend upon design considerations such as; customer requirements, retrofit considerations, application fit, performance characteristic to be achieved etc., as would be understood by one of ordinary skill.

The back plates and brake pads used today often give a wedge-shaped or triangular space adjacent to the rotating central part or sleeve connected to the hub. The sleeve often has teeth for torque transmission to the disc or discs. In some designs used today a wedge-shaped or triangular space instead appears adjacent to a cylindrical part of the brake disc. As the sleeve, or a cylindrical part of a brake disc, rotates in one of its possible directions it will move the side of the wedge-shaped space towards the apex of the wedge. A stone or other foreign object may, thus, be drawn towards the apex of the wedge and cause damage of some kind. In case of teeth on the sleeve they will give a good grip of the stone or other object.

Thus, one further object of the present invention is to reduce the risk that stones or other foreign objects are drawn into the brake, causing damages.

The back plates are normally adapted to the type of disc brake in which they are placed. Often they are also adapted to the position in the brake. Thus, the back plate closest to the brake actuator may differ from the next back plate, which in turn may differ from the back plate furthest from the brake actuator. A back plate may also look different at the respective side which is active when the vehicle goes forward or backward.

Further objects and advantages of the present invention will be obvious to a person skilled in the art when reading the detailed description below of at present preferred embodiments.

### BRIEF DESCRIPTION OF THE DRAWINGS

The invention will be described further below by way of examples and with reference to the enclosed drawings.

In the drawings:

FIG. 1 is a perspective view of a back plate according to the present invention;

FIG. 2 is a perspective view of a part of a disc brake including alternative back plates according to the present invention;

FIG. 3 is a part view, in perspective, illustrating a back plate elastically received in a caliper;

FIG. 4a is a principal sketch of a disc brake according to prior art and a hysteresis curve for said brake; and

FIG. 4b is a principal sketch and hysteresis curve corresponding to FIG. 4a of a disc brake according to the present invention.

### DETAILED DESCRIPTION OF THE INVENTION

The principals of the present invention apply for disc brakes having many different structures. Only parts important for the understanding of the present invention will be specifically referred to in the description below. As the pad receiving means of the present invention could be used in any type of disc brake, the brake as such will not be described extensively. In a disc brake the brake discs are arranged sliding or not sliding on a sleeve or the like. Also the brake pads are arranged on back plates or the like sliding or not sliding in a caliper or the like. In braking, the brake disc(s) and brake pad(s) are moved in relation to each other to form a contact.

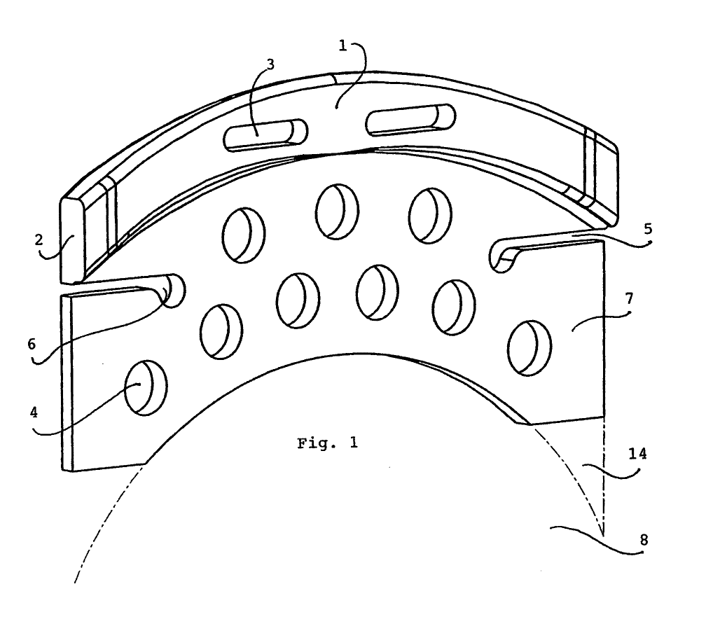

The back plate 1 of FIG. 1 has an approx. rectangular outline. The long sides of the rectangular being more or less curved. At the uppermost part of the short sides of the back plate 1 surfaces 2 are arranged, which surfaces are to be in contact with corresponding surfaces of a caliper. In the shown embodiment two openings 3 are arranged at the top of the back plate 1, for cooperation with holding and/or guiding means. This is only one example of how the back plates 1 may be held and/or guided. A person skilled in the art realizes that back plates may be furnished with any known type of holding and/or guiding means. A number of further openings 4 are arranged on the back plate 1, in the area in which the brake pad is to be received. These further openings are of importance regarding bonding of the friction material to the back plate, and may not be necessary.

At each short side of the back plate 1 a groove 5 is arranged going mainly perpendicular in relation to the short side. Expressed differently the grooves are linear and extend approximately perpendicular to the direction of actuation movement of the back plate 1. The grooves 5 are arranged just below the contact surfaces 2 referred to above. Each groove 5 ends at the inner part with a rounded part 6. Due to the grooves 5 the flexibility of the back plate 1 is increased. During braking the back plate 1 will flex in relation to the contact surfaces 2, forming upper contact points with the caliper. The parts 7 of the back plates 1 placed under the grooves 5 will be pressed against the brake disc. The parts of the back plate 1 placed above the grooves 5 will flex rather extensively during braking, in relation to the lower parts 7. Thus, a part of the movement between caliper and back plate at braking will be taken up elastically by the flexible back plates 1 of the present invention.

In other embodiments one or more back plates have only one groove 5. The flexibility of the back plate is normally only in practice needed on that side which is active during a braking when the vehicle moves forward.

In FIG. 1 a sleeve 8 or other part receiving the brake discs (not shown) is indicated. The sleeve 8 rotates with the wheel when the vehicle moves. Small stones or the like may end up in the triangular (wedge-shaped) area 14 (indicated by dashed lines) formed between the back plate 1 and the sleeve 8, and below the outer edges of the back plate 1. As the sleeve 8 or the like is rotating the stones etc. risk being dragged into and be seized in the apex between sleeve 8 and back plate 1. This may harm the brake and impair the braking function. A similar situation may occur in a wedge shaped area formed between the back plate and a brake disc designed with a cylindrical part.

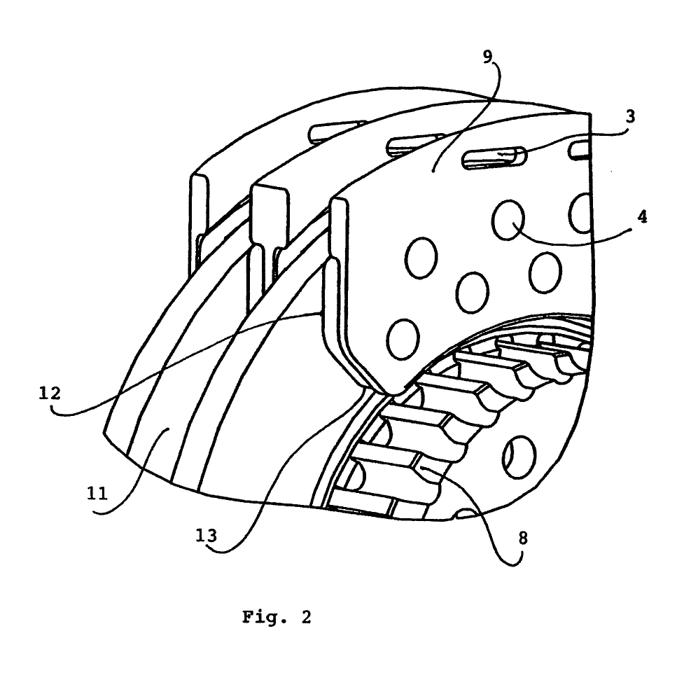

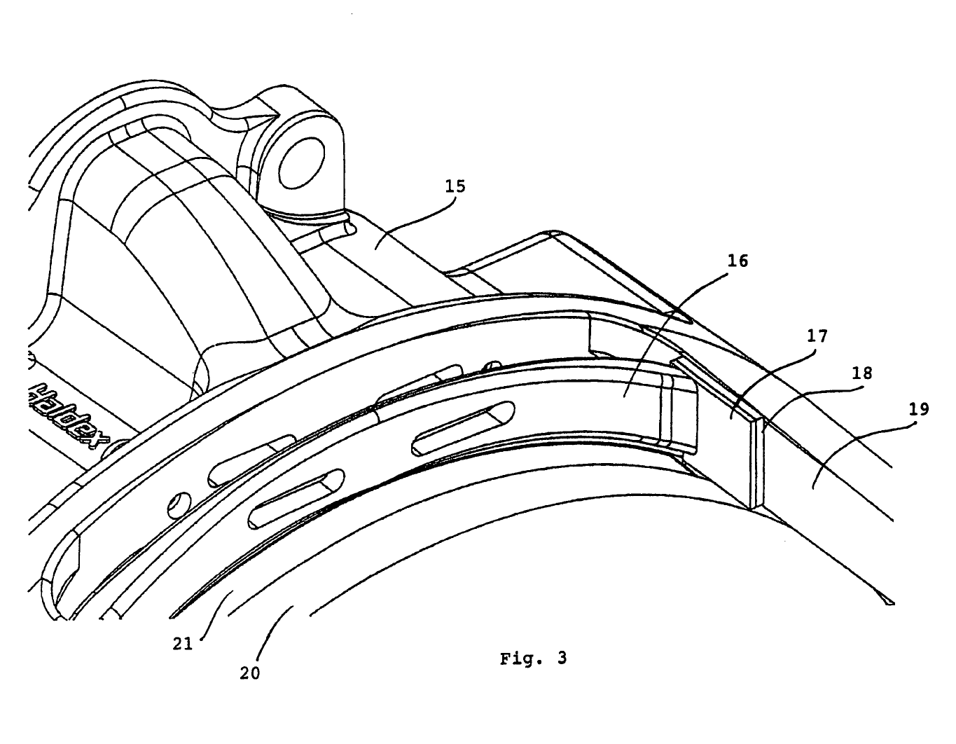

In FIG. 2 an example of a disc brake is shown in a partial view. In this example alternative back plates 9 are shown. Brake discs 11 are to cooperate with brake pads 12 received on the back plates 9 to accomplish the braking force wanted. Also this back plate has openings 3, for guiding and/or holding means, and openings 4, for bonding purposes. The back plate 9 has contact surfaces 10 for cooperation with a caliper. In this case the caliper will give the elasticity given by the grooves 5 of the back plates 1 of FIG. 1. The contact surfaces of the caliper have a shearing elasticity, which will be described further below in connection with FIG. 3. In one embodiment the caliper has outer parts in the form of wings, which receives spring member's, for example in a polymer material. The back plates may have different designs depending on in which type of disc brake they are placed. The design of the back plates may also vary in one disc brake, depending on where in the brake the back plate is placed. E.g. for a brake having a fixed caliper the flexibility is most important for the back plate positioned closest to the brake mechanism, while it has no function for a back plate positioned on the opposite side, i.e. furthest from the brake mechanism.

In the embodiment illustrated in FIG. 3 the flexibility is given in the contact between a caliper 15, and a back plate 16. A layer 18 of an elastic material is placed on a guide surface 19 of the caliper 15. The layer 18 of elastic material is placed in the area of the guide surface 19 in which the back plate 16 is to be received. A plate 17 is arranged on the layer 18 of elastic material. The function of the plate 17 is to protect the elastic material from an excessive contact pressure and/or wear. In the shown embodiment a brake disc 20 and a brake pad 21 are indicated. During braking the back plate 16 will move without sliding during actuation force buildup in relation to the caliper 15, by means of the layer 18 of elastic material. By use of the layer 18 of elastic material the contact surfaces between the caliper 15 and the back plates 16 will have a shearing elasticity. The arrangement with the layer 18 of elastic material is an alternative to flexible back plates 1 of the kind illustrated by FIG. 1. A person skilled in the art realizes that the two alternatives may be combined. Thus, in some embodiments a flexible back plate 1 is received elastically in the caliper 15 by means of a layer 18 of elastic material.

In order to reduce the risk that stones or the like are drawn into and seized between the sleeve 8 or the like and the back plates 9, the lower corners of each back plate 9 are shaped to avoid a wedge-like area, for example by use of a contour 13 being close to radial from the rotation centre of the sleeve. It is the side of the back plate 9 that is active when driving forward that is most critical regarding possible trapped stones or the like. Therefore in some back plates it is only on that side the lower corner shows a contour 13.

In other embodiments the problem with possible stones are dealt with in other ways. One solution is to make the space between back plate and sleeve big enough for all foreseeable stones to pass through the triangular area 14. Another solution is to arrange a protecting cover at the pad edges turning possible stones away. A protection may also be placed covering the teeth of the sleeve 8. The protection is fixed to the pad or one or more parts connected to the pad. A further solution is to arrange a cover on the inside of the wheel rim.

During braking one of the contact surfaces 2, 10 of the back plates 1, 9, 16 or other pad receiving means will be pressed against the caliper, due to the rotation of the brake discs 11, 20. The direction of rotation of the brake discs 11, 20 dictates which contact surface 2, 10 of each back plate 1, 9 that will be pressed against the caliper. Due to the flexibility of each specific back plate or other pad receiving means and/or the caliper the contact will be more or less without sliding during actuation force buildup and the friction forces between back plate or other pad receiving means and caliper in the direction of pad movement is taken up by said flexibility. The total flexibility of the back plate 1 or other pad receiving means and/or the caliper 15 should be of the same magnitude as the sliding along the abutments would have been during actuation force buildup, if the back plates or other pad receiving means were stiff. Due to the flexibility of the back plate 1, 9 or other pad receiving means and/or ‘the caliper 15 the hysteresis in the relationship between actuation force and braking torque will be greatly reduced.

A person skilled in the art realizes that the features of the different back plates or other pad receiving means and calipers referred to above may be combined in any way. E.g. the back plate of FIG. 2 may be furnished with grooves to give flexible back plates.

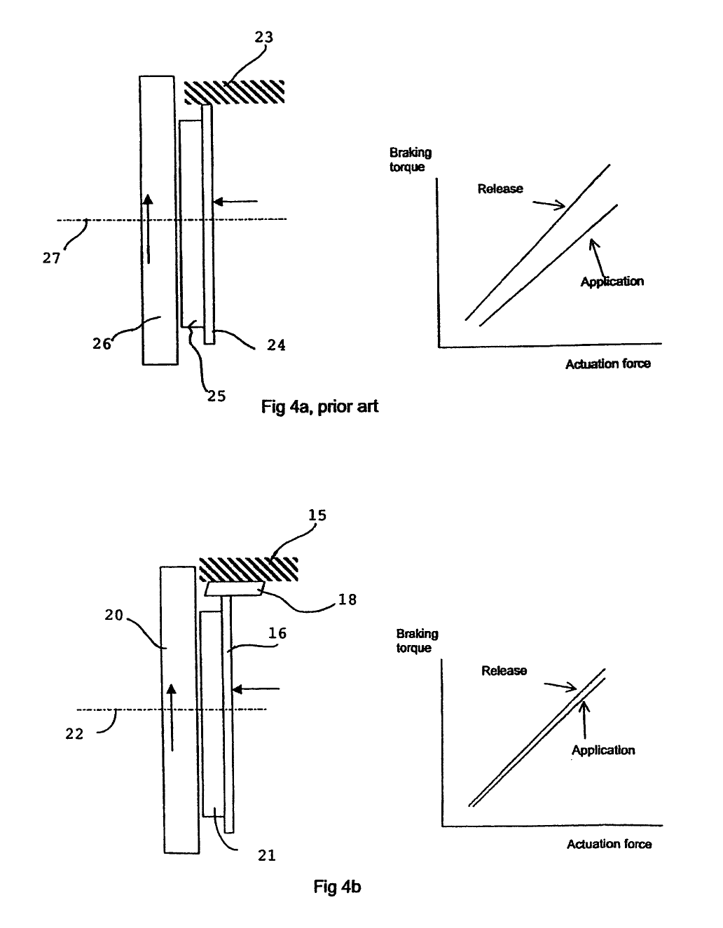

FIG. 4a is a principal sketch of a disc brake according to the prior art, illustrating brake application. The disc brake has a caliper 23 against which a back plate or other pad receiving means 24 will slide during brake actuation. At brake application a brake pad 25 on the pad receiving means 24 will be pressed against a brake disc 26, in the direction of the arrow. The brake disc 26 rotates around a rotational axis 27 in the direction indicated by the arrow on the brake disc 26. When the brake is released the pad receiving means 24 will move in the opposite direction to the arrow. As indicated above there will be a hysteresis between the application and release phases, caused by the sliding of the pad receiving means 24 against the caliper 23. The magnitude of said hysteresis is illustrated by the graph of FIG. 4a.

FIG. 4b corresponds to FIG. 4a but shows a disc brake according to the present invention. The brake of FIG. 4b corresponds to the embodiment of FIG. 3 having an elastic caliper element 18. When the brake is applied, in that the back plate 16 and brake pad 21 is pressed against the brake disc 20, rotating around a rotational axis 22, some of the movement is taken up by the elastic element 18, as indicated above. When the brake is released the elastic element 18 will go back to its original shape, taking up a part of the movement. By means of the elastic element 18 the hysteresis is reduced, illustrated in that the application and release parts of the graph of FIG. 4b are closer to each other, compared to a brake according to ‘the prior art. A person skilled in the art realizes that the same effect, i.e. reduced hysteresis, will be achieved also with a flexible back plate according to the embodiment of FIG. 1 or with a combination of a flexible back plate and an elastic element of the caliper.

What is claimed is:

1. A disc brake comprising a brake disc received on a sleeve connected to a wheel mount, a caliper and a brake pad received on a back plate, characterized in that the back plate is elastically flexible in the direction of movement of the brake pad during brake application.

2. The disc brake of claim 1, characterized in that the magnitude of the flexibility is predetermined in view of expected actuation movements in the brake.

3. (canceled)

4. The disc brake of claim 1, characterized in that the back plate has a surface for contact with the caliper.

5. The disc brake of claim 1, characterized in that the back plate is furnished with a groove to give the flexibility.

6. The disc brake of claim 5, characterized in that the groove is arranged at a level below a contact point between the back plate and the caliper.

7. The disc brake of claim 6, characterized in that the back plate has a second groove.

8. The disc brake of claim 5, characterized in that the groove has a first mainly linear part, that extends approximately perpendicular to the direction of actuation movement of the back plate, and ends in a rounded part placed towards the centre of the back plate.

9. (canceled)

10. (canceled)

11. The disc brake of claim 1, characterized in that the flexibility is big enough to hinder the brake pad to caliper forces in the direction of the brake pad movement to alter direction between an actuation phase and a release phase.

12. The disc brake of claim 1, characterized in that parts of the brake are formed to avoid the appearance of a wedge-like area between the back plate and the sleeve.

13. The disc brake of claim 12, characterized in that the lower corners of the back plate show a contour that avoids the appearance of the wedge-like area.

14. The disc brake of claim 12, characterized in that the space between the back plate and the sleeve is made big enough to let all foreseeable stones to pass.

15. The disc brake of claim 1, characterized in that parts of the brake are formed to avoid access to a wedge-like area between the back plate and the sleeve.

16. The disc brake of claim 15, characterized in that a protecting cover is arranged at the edges of the back plate.

17. The disc brake of claim 15, characterized in that a protection is placed covering the teeth of the sleeve.

18. The disc brake of claim 15, characterized in that a cover is arranged on the inside of the wheel rim.

19. The disc brake of claim 1, characterized in that parts of the brake are formed to avoid access to a wedge-like area between the back plate and the brake disc.

20. The disc brake of claim 19, characterized in that a protecting cover is arranged at the edges of the back plate.

21. The disc brake of claim 19, characterized in that a cover is arranged on the inside of the wheel rim.

22. The disc brake of claim 1, characterized in that parts of the brake are formed to avoid the appearance of a wedge-like area between the back plate and the brake disc.

23. A disc brake comprising a brake disc received on a sleeve connected to a wheel mount, a caliper and a brake pad received on a back plate, characterized in that the caliper is elastically flexible in the direction of movement of the brake pad during brake application.

24. The disc brake of claim 23, characterized in that the caliper is furnished with a spring element to give the desired flexibility.

25. The disc brake of claim 24, characterized in that the spring element is a layer made of a polymer material, which layer is placed on a guide surface of the caliper in an area in which the back plate is to be received.

26. The disc brake of claim 24, characterized in that the spring element is a layer made of a polymer material, which layer is placed on a guide surface of the caliper and that the layer is covered by a plate.

27. The disc brake of claim 24, characterized in that the spring element is a layer made of a polymer material, which layer is placed on a guide surface of the caliper in an area in which the back plate is to be received, and that the layer is covered by a plate.

28. The disc brake of claim 23, characterized in that the flexibility is big enough to hinder the brake pad to caliper forces in the direction of the brake pad movement to alter direction between an actuation phase and a release phase.

29. A disc brake comprising a brake disc received on a sleeve connected to a wheel mount, a caliper and a brake pad received on a back plate, characterized in that the caliper and the back plate are elastically flexible in the direction of movement of the brake pad during brake application.
